(19) United States
(12) Patent Application Publication
(10) Pub. No.: US 2024/0397931 A1
(43) Pub. Date: Dec. 5, 2024

(54) REPELLENCE SYSTEM AND REPELLENCE METHOD FOR REPELLING ANIMALS

(71) Applicant: FLOX AB, Sundbyberg (SE)

(72) Inventors: Matteo TADIELLO, Sundbyberg (SE); Marco MOLETTA, Sundbyberg (SE)

(21) Appl. No.: 18/698,850

(22) PCT Filed: Oct. 7, 2022
(86) PCT No.: PCT/SE2022/050901

§ 371 Date: Apr. 5, 2024

(30) Foreign Application Priority Data
Oct. 8, 2021 (SE) 2151236-3

(51) Int. Cl. A01M 29/10; A01M 29/18; G05D 1/485; G05D 1/686; G05D 105/50; G05D 105/85; G05D 109/20; G05D 111/10; G06V 20/17; G06V 40/10

(52) U.S. Cl. CPC A01M 29/10; A01M 29/18; G05D 1/485; G05D 1/686; G06V 20/17; G06V 40/10; G05D 2105/50; G05D 2105/85; G05D 2109/20; G05D 2111/10

(57) ABSTRACT

A repellence system and method for repelling animals. The repellence system includes an imaging device arranged to generate image data from a surveillance area, one or more deterrence devices arranged to carry out deterrence actions for repelling animals and an repellence sub-system having one or more processors and memory storing instructions for execution by the one or more processors. The repellence sub-system being configured to receive image data of the surveillance area from the imaging device, detect an animal in the image data, identify animal species of the detected animal in the image data, provide species specific deterrence instructions to the one or more deterrence devices based on the identified animal species.

### FIELD OF THE INVENTION

The present invention relates to a repellence system for repelling animals and more particularly to a repellence system according to preamble of claim 1. The present invention further relates to repellence method for repelling animals and more particularly to a repellence method according to preamble of claim 14.

### BACKGROUND OF THE INVENTION

Wild animals are a special challenge for farmers. Wild animals may cause serious damage to crops, as they can damage the plants by feeding on plant parts or simply by running over the field and trampling over the crops. Therefore, wild animals may easily cause significant yield losses. Wild animals also cause dangerous situations in traffic which may further cause accidents and even loss of human and animal lives. To avoid damage to crops and traffic accidents several kinds of repellence methods are commonly known. Different kinds of fences have been used to prevent animals from entering fields as well as roads or train tracks. However, the fences are laborious to install and require continuous maintenance work. Chemical and electrical repellents are also used in prior art to repel animals. The chemical and electrical repellents are usually effective only for limited animal species and therefore several methods are necessary to be used for increasing effectiveness.

### BRIEF DESCRIPTION OF THE INVENTION

An object of the present invention is to provide a repellence system and repellence method such that the prior art disadvantages are solved or at least alleviated.

The objects of the invention are achieved by a repellence system which is characterized by what is stated in the independent claim 1. The objects of the invention are also achieved by a repellence method which is characterized by what is stated in the independent claim 14.

The preferred embodiments of the invention are disclosed in the dependent claims.

The invention is based on the idea of providing a repellence system for repelling animals. The repellence system comprises an unmanned vehicle comprising an imaging device arranged to generate image and one or more deterrence devices arranged to carry out deterrence actions for repelling animals. The repellence system further comprises a repellence repellence sub-system having one or more processors and memory storing instructions for execution by the one or more processors. The repellence repellence sub-system being configured to
control movement of the unmanned vehicle in a predetermined geographical surveillance area having a surveillance area border defining the predetermined geographical surveillance area,
receive image data of the predetermined geographical surveillance area from the imaging device during movement of the unmanned vehicle in the predetermined surveillance area,
detect an animal in the image data with the repellence repellence sub-system,
identify animal species of the detected animal in the image data with the repellence repellence sub-system,
control the unmanned vehicle towards the detected and identified animal in the predetermined geographical surveillance area, and
provide species specific deterrence instructions to the one or more deterrence devices based on the identified animal species for carrying out species specific deterrence actions with the deterrence device, the species specific deterrence instructions being specific to the identified animal species.

Accordingly, the repellence system of the present invention enables producing deterrence actions specific to the animal species identified in the surveillance area during the movement of the unmanned vehicle towards the animal. Thus, the repellence of the animals is highly effective and enables repelling the animal to a desired direction.

In the context of this application the term animal species means especially different animal families, for example, but not limited to, pigs, deers, bears, or birds. In some embodiments of the present invention the term animal species means different species within one animal family, such as different kinds of birds.

In some embodiments, the repellence sub-system is configured to control movement of the unmanned vehicle in the predetermined geographical surveillance area in an autonomous manner.

Thus, no manual control in needed and the unmanned vehicle is configured to patrol according to control instructions provide by the repellence sub-system.

In some other embodiments, the repellence sub-system is configured to control movement of the unmanned vehicle in the predetermined geographical surveillance area along a predetermined surveillance path.

Accordingly, the unmanned vehicle is configured to patrol according to predetermined control instructions provide by the repellence sub-system.

In some further embodiments, the repellence sub-system is configured to maintain geographical location information of the predetermined geographical surveillance area and control movement of the unmanned vehicle in the predetermined geographical surveillance area.

The maintain geographical location information of the predetermined geographical surveillance area is stored to the repellence sub-system.

The geographical location information of the predetermined geographical surveillance area is determined with global navigation satellite system (GNSS) coordinates, such as Global Navigation System (GPS) coordinates.

Tus, the unmanned vehicle is configured to patrol in the predetermined geographical surveillance area according to the control instructions provide by the repellence sub-system.

The unmanned vehicle is provided with GNSS receiver configured to receive GNSS signals from GNSS satellites, such as GPS satellites. The repellence sub-system is configured determine vehicle location information of the unmanned vehicle based on the GNSS signals received in the GNSS receiver of the unmanned vehicle.

Accordingly, the repellence sub-system is configured to control the movement of the unmanned vehicle in the predetermined geographical surveillance area based on the geographical location information of the predetermined geographical surveillance area and the vehicle location information of the unmanned vehicle.

In some yet further embodiments, the repellence sub-system is configured maintain geographical location information of the predetermined geographical surveillance area and control movement of the unmanned vehicle in the predetermined geographical surveillance area in an autonomous manner or along a predetermined surveillance path.

Utilizing the GNSS coordinates for the predetermined geographical surveillance area and the GNSS receiver and GNSS signals for the vehicle location information may be utilized in all embodiments of the present invention.

In one embodiment, the imaging device is a thermographic imaging device configured to generate thermographic image data. The thermographic imaging device enables detecting and identifying animals also during night.

In another embodiment, the imaging device is an infrared imaging device configured to generate infrared image data. Also, the infrared imaging device enables detecting and identifying animals also during night.

In a further embodiment, the imaging device is a digital colour imaging device configured to generate colour image data. The digital colour imaging device enables utilizing colours in the image data for identifying the animal species.

In yet another embodiment, the imaging device is a Lidar camera having a lidar sensor and configured to generate range image data. Lidar is an acronym of “light detection and ranging” or “laser imaging, detection, and ranging”. Lidar cameras may also be used measuring distance to the detected animal.

In yet another embodiment, the imaging device is an RGB-D camera configured to generate range image data. RGD-D is an acronym of “Red Green Blue-Depth”. RGB-D camera provides depth information associated with corresponding RGB data. RGB-D camera is configured to produce a 2D image showing the distance to points in a scene from a specific point, normally associated with some type of sensor device. The resulting image, the range image, has pixel values that correspond to the distance.

Further in the context of this application, the repellence system comprises one or more imaging devices. In some embodiments, all the imaging devices are similar-type imaging devices, such as thermographic imaging devices, or infrared imaging devices or digital colour imaging devices. In some other embodiments, the repellence system may comprise two or more different type of imaging devices, such as any combination of thermographic, infrared and digital colour imaging devices, Lidar cameras and RGB-D cameras.

In one embodiment, the repellence sub-system is configured to receive video image data from the imaging device.

In another embodiment, the repellence sub-system is configured to receive thermographic video image data from the thermographic imaging device.

In another embodiment, the repellence sub-system is configured to receive infrared video image data from the infrared imaging device.

In another embodiment, the repellence sub-system is configured to receive colour video image data from the colour imaging device.

Providing the image data in video format and receiving the video image data in the repellence sub-system enables analysing the image in greater detail and frequency.

In one embodiment, the repellence sub-system is configured to automatically detect the animal in the image data with a computer vision algorithm, the computer vision algorithm being trained to detect animal in the image data.

In another embodiment, the repellence sub-system is configured to input the image data as first input image data to a computer vision algorithm, and automatically detect the animal in the first input image data with the computer vision algorithm, the computer vision algorithm being trained to detect animal in the first input image data.

In a further embodiment, the repellence sub-system is configured to input the video image data as first input image data to a computer vision algorithm, and automatically detect the animal in the first input image data with the computer vision algorithm by processing each frame of the video image data with the computer vision algorithm to detect the animal, the computer vision algorithm being trained to detect animal in the first input image data.

The computer vision algorithm may be any known algorithm capable of and trained to detect animal(s) in image data. This enables efficient and quick detection of animal(s) in the surveillance area.

Accordingly, the repellence system and/or the computer vision algorithm may be configured to detect one or more animals in the first input data.

In any one of the embodiments of the present invention, the repellence system and/or the computer vision algorithm may be configured to automatically detect and identify number of animals in the first input image data.

In one embodiment, the repellence sub-system is configured to automatically identify the animal species of the detected animal in the image data with an image identification algorithm, the image identification algorithm being trained to identify different animal species from the image data.

In another embodiment, the repellence sub-system is configured to input the image data as second input image data to an image identification algorithm, and automatically identify animal species of the detected animal in the second input image data with the image identification algorithm, the image identification algorithm being trained to identify different animal species from the second input image data.

In a further embodiment, the repellence sub-system is configured to input the video image data as second input image data to an image identification algorithm, and automatically identify animal species of the animal in the second input image data with the image identification algorithm by processing one or more frames of the video image data with the image identification algorithm to identify animal species of the animal, the image identification algorithm being trained to identify different animal species from the second input image data.

Utilizing the image identification algorithm configured to and trained to identify animal species of the detected animal enables selecting most efficient deterrence actions for repelling the detected animals in automatic or autonomous manner in a quick manner.

Utilizing separate computer vision algorithm for detecting animals and image identification algorithm for identifying animal species provides efficient processing as the image identification algorithm may be utilized only when an animal or potential animal is detected in the image data with the computer vision algorithm.

In an alternative embodiment, the repellence sub-system is configured to automatically identify the animal species of the detected animal in the image data with the computer vision algorithm, the computer vision algorithm being trained to identify different animal species from the image data.

In another embodiment, the repellence sub-system is configured to input the image data as the first input image data to the computer vision algorithm, and automatically identify animal species of the detected animal in the first input image data with the computer vision algorithm, the computer vision algorithm being trained to identify different animal species from the first input image data.

In a further embodiment, the repellence sub-system is configured to input the video image data as the first input image data to the computer vision algorithm, and automatically identify animal species of the animal in the first input image data with the computer vision algorithm by processing one or more frames of the video image data with the computer vision algorithm to identify animal species of the animal, the computer vision algorithm being trained to identify different animal species from the first input image data.

Utilizing the computer vision algorithm for both detecting animals and identifying animal species of the detected animals make the system fast and efficient in providing detection and identification of animals. Thus, the computer vision algorithm is configured to and trained to detect and identify animal species. Thus, in these embodiments there is only one algorithm for both detecting animals and identifying animal species.

In some embodiments, the repellence sub-system comprises an identification database having two or more animal species profiles stored in the identification database, each of the animal species profiles being specific to one animal species.

In one embodiment, the repellence sub-system is configured to define an animal species profile corresponding the identified animal species of the detected animal based on the identification.

In another embodiment, the repellence sub-system is configured to utilize a classification algorithm as the image identification algorithm, and classify the detected animal to an animal species, and define an animal species profile corresponding the identified animal species of the detected animal to an animal species profile based on the classification.

In a further embodiment, the repellence sub-system is configured to utilize a classification algorithm as the compute vision algorithm, and classify the detected animal to an animal species, and define an animal species profile corresponding the identified animal species of the detected animal to an animal species profile based on the classification.

Accordingly, the detected animal may be associated to the animal species profile corresponding the identified animal species of the detected animal. The animal species profile may further comprise species specific deterrence instructions.

The detection and/or identification algorithms may be based on neural networks. Examples of specific algorithms comprise Faster R-CNN (Region Based Convolutional Neural Network), YOLO (You Only Look Once), SSD (Single Shot MultiBox Detector) and R-FCN (Region-based Fully Convolutional Networks).

In one embodiment, the one or more deterrence devices comprise a deterrence sound device arranged to generate species specific deterrence sound action as the deterrence action in response to the species specific deterrence instructions. The detected and identified animal may be repelled by emitting species specific deterrence sounds from the deterrence sound device.

In an alternative embodiment, the one or more deterrence devices comprise a deterrence ultrasound device arranged to generate species specific deterrence ultrasound action as the deterrence action in response to the species specific deterrence instructions. The detected and identified animal may be repelled by emitting species specific deterrence ultrasound from the deterrence ultrasound device.

Ultrasound is sound waves with frequencies higher than the upper audible limit of human hearing. In the present application ultrasound means sound frequencies from 20 kHz up, for example to 100-300 kHz. The frequency of the ultrasound may vary based on the identified animal species. Accordingly, the deterrence ultrasound device is arranged to generate species specific deterrence ultrasound having pre-determined frequency based on the identified animal species.

In a further embodiment, the one or more deterrence devices comprise a deterrence light device arranged to generate species specific deterrence light action as the deterrence action in response to the species specific deterrence instructions. The detected and identified animal may be repelled by emitting species specific deterrence light from the deterrence light device.

In yet another embodiment, the one or more deterrence devices comprise a deterrence sound device arranged to generate species specific deterrence sound action and a deterrence light device arranged to generate species specific deterrence light action as the deterrence actions in response to the species specific deterrence instructions. The detected and identified animal may be repelled by emitting species specific deterrence sounds and light from the deterrence sound and light devices.

In a yet further embodiment, a deterrence ultrasound device arranged to generate species specific deterrence ultrasound action and a deterrence light device arranged to generate species specific deterrence light action as the deterrence actions in response to the species specific deterrence instructions. The detected and identified animal may be repelled by emitting species specific deterrence ultrasounds and light from the deterrence ultrasound and light device.

In one embodiment, the repellence sub-system is configured to generate species specific deterrence instructions based on the identification of the animal species of the detected animal, and provide the generated species specific deterrence instructions to the one or more deterrence devices.

In another embodiment, each of the two or more animal species profiles comprise species specific deterrence instructions specific to the respective animal species, the species specific deterrence instructions comprising instructions to carry out species specific deterrence actions with the one or more deterrence devices specific to the animal species.

The repellence sub-system is configured to carry out the species specific deterrence actions based on the species specific deterrence instructions of the animal species profile corresponding the identified animal species of the detected animal.

Alternatively, the repellence sub-system is configured to provide the species specific deterrence instructions of the animal species profile corresponding the identified animal species of the detected animal to the one or more deterrence devices, and operate the one or more deterrence devices based on the species specific deterrence instructions corresponding the animal species profile of the identified animal species o the detected animal to generate species specific deterrence actions with the one or more deterrence devices.

In some embodiments the identification database comprises at least deers profile, boars/wild pigs profile, humans profile and birds profile. Each of the profiles is provided with species specific deterrence instructions.

The deers profile comprises deers deterrence instructions. The hearing range of deers is from 32 Hz to 64 kHz. The deers deterrence instructions comprise instructions to utilize and adjust the sound and/or ultrasound deterrence device to utilize deterrence sound in the hearing range of the deers between the 32 Hz and 64 kHz. In a preferred embodiment, the deers deterrence instructions comprise instructions to utilize and adjust the ultrasound deterrence device to utilize deterrence ultrasound in the range between the 20 Hz and 64 kHz. This deterrence ultrasound cannot be heard by humans.

The boars or wild pigs profile comprises boars or wild pigs deterrence instructions. The hearing range of boars or wild pigs is from 42 Hz to 40.5 kHz. The boars or wild pigs deterrence instructions comprise instructions to utilize and adjust the sound and/or ultrasound deterrence device to utilize deterrence sound in the hearing range of the boars or wild pigs between the 42 Hz and 40.5 kHz. In a preferred embodiment, the boars or wild pigs deterrence instructions comprise instructions to utilize and adjust the ultrasound deterrence device to utilize deterrence ultrasound in the range between the 20 Hz and 40.5 kHz. This deterrence ultrasound cannot be heard by humans.

The humans profile comprises human deterrence instructions. The hearing range of humans is from 20 Hz to 20 KHz. The human deterrence instructions comprise instructions to utilize and adjust the sound and/or ultrasound deterrence device to utilize deterrence sound in the hearing range of the humans between the 20 Hz and 20 kHz.

The birds profile comprises birds deterrence instructions. The hearing range of birds is from 1 kHz to 4 kHz. The birds deterrence instructions comprise instructions to utilize and adjust the sound deterrence device to utilize deterrence sound in the hearing range of the birds between the 1 kHz and 4 kHz. Accordingly, the one or more deterrence devices are operated based on the species specific deterrence instructions such that the most efficient deterrence actions are used for different animal species.

In one embodiment, the one or more deterrence devices comprise the deterrence ultrasound device. The repellence sub-system is configured to carry out the species specific deterrence actions by utilizing a species specific ultrasound frequency value in the deterrence ultrasound device based on the identified animal species of the detected animal, the species specific deterrence instructions comprising the species specific ultrasound value.

In another embodiment, the one or more deterrence devices comprise the deterrence ultrasound device. The repellence sub-system is configured to generate species specific deterrence instructions comprising a species specific ultrasound frequency value for the deterrence ultrasound device based on the identified animal species of the detected animal, provide the generated species specific deterrence instructions to the deterrence ultrasound device, and operate the deterrence ultrasound device with the species specific ultrasound frequency value of the species specific deterrence instructions.

In a further embodiment, each of the two or more animal species profiles comprise species specific deterrence instructions specific to the respective animal species, the species specific deterrence instructions comprising species specific ultrasound frequency value to be utilized by the deterrence ultrasound device. The repellence sub-system is configured to carry out the species specific deterrence actions by utilizing the species specific ultrasound value in the deterrence ultrasound device based on the species specific deterrence instructions of the animal species profile corresponding the identified animal species o the detected animal.

In a yet further embodiment, each of the two or more animal species profiles comprise species specific deterrence instructions specific to the respective animal species, the species specific deterrence instructions comprising species specific ultrasound frequency value to be utilized by the deterrence ultrasound device. The repellence sub-system is configured to provide the species specific deterrence instructions of the animal species profile corresponding the identified animal species of the detected animal to the deterrence ultrasound devices, the species specific deterrence instructions comprising a species specific ultrasound frequency value, and operate the deterrence ultrasound device with the species specific ultrasound frequency value of the species specific deterrence instructions of animal species profile corresponding the identified animal species of the detected animal.

Different animal species have different hearing ranges and therefore different ultrasound frequencies and sound frequencies are efficient in repelling different animal species. Ultrasound is efficient in repelling animals and it does not harm the animals. Ultrasound is also be silent to humans in high-frequencies over 20 KHz.

In an alternative embodiment, the repellence system is configured to store a pre-determined deterrence distance threshold value, determine distance between the imaging device and the detected animal, and initiate the species specific deterrence actions with the one or more deterrence devices when the determined distance is equal to or less than the pre-determined deterrence distance threshold value. Accordingly, the deterrence actions are carried out only when the detected animal is within the predetermined deterrence distance such that the deterrence is effective in repelling the animal.

In some embodiment, the repellence sub-system is configured to control movement of the unmanned vehicle towards the detected and identified animal in the predetermined geographical surveillance area, and initiate the species specific deterrence actions with the one or more deterrence devices during the movement of the unmanned vehicle towards the detected and identified animal.

This enables repelling the animal to a desired direction.

In some other embodiment, the repellence sub-system is configured to control movement of the unmanned vehicle towards the detected and identified animal in the predetermined geographical surveillance area and measure distance between the unmanned vehicle and the animal, and initiate the species specific deterrence actions with the one or more deterrence devices when the distance between the unmanned vehicle and the animal equal or less than the predetermined deterrence distance threshold value.

In some embodiments, the repellence sub-system is configured to determine location of the detected and identified animal in the predetermined geographical surveillance area in relation to the surveillance area border and control movement of the unmanned vehicle towards the detected and identified animal in the predetermined geographical surveillance area in an approach direction in which the detected and identified animal is located between the unmanned vehicle and the surveillance area border for repelling the animal out of the predetermined geographical surveillance area.

The repellence sub-system is configured to determine the location of the detected animal based on the geographical location information of the predetermined geographical surveillance area, the vehicle location information and the image data from the imaging device.

In some embodiments, the repellence sub-system is configured to determine location of the detected and identified animal in the predetermined geographical surveillance area in relation to the surveillance area border and control movement of the unmanned vehicle towards the detected and identified animal and towards the surveillance area border in the predetermined geographical surveillance area in an approach direction in which the detected and identified animal is located between the unmanned vehicle and the surveillance area border for repelling the animal out of the predetermined geographical surveillance area.

In some embodiments, the repellence sub-system is configured to determine moving direction of the detected and identified animal based on the image data from the imaging device, and control the unmanned vehicle towards the detected and identified based on the moving direction of the detected and identified animal in the predetermined geographical surveillance area.

In some other embodiments, the repellence sub-system is configured to determine location and moving direction of the detected and identified animal based on the image data from the imaging device, and control the unmanned vehicle towards the detected and identified based on the location and moving direction of the detected and identified animal in the predetermined geographical surveillance area.

In some further embodiments, the repellence sub-system is configured to determine location and moving direction of the detected and identified animal in the predetermined geographical surveillance area in relation to the surveillance area border based on the image data from the imaging device, and control the unmanned vehicle towards the detected and identified based on the location and moving direction of the detected and identified animal in the predetermined geographical surveillance area in the approach direction in which the detected and identified animal is located between the unmanned vehicle and the surveillance area border for repelling the animal out of the predetermined geographical surveillance area.

In some yest further embodiments, the repellence sub-system is configured to determine location and moving direction of the detected and identified animal in the predetermined geographical surveillance area in relation to the surveillance area border based on the image data from the imaging device, control the unmanned vehicle towards the detected and identified based on the location and moving direction of the detected and identified animal in the predetermined geographical surveillance area in the approach direction in which the detected and identified animal is located between the unmanned vehicle and the surveillance area border for repelling the animal out of the predetermined geographical surveillance area, and
redetermine the location and moving direction of the detected and identified animal in the predetermined geographical surveillance area in relation to the surveillance area border based on the image data from the imaging device, adjusting the approach direction based on the redetermined location and moving direction of the detected and identified animal in the predetermined geographical surveillance area such the detected and identified animal is located between the unmanned vehicle and the surveillance area border for repelling the animal out of the predetermined geographical surveillance area.

The repellence sub-system is configured to control towards the animal and/or determined the approach direction based on the geographical location information of the predetermined geographical surveillance area, the vehicle location information and the image data from the imaging device.

In some embodiments, the unmanned vehicle is an unmanned aerial vehicle, such as a drone or plane.

In some other embodiments, the unmanned vehicle is an unmanned ground vehicle.

In some other embodiments, the repellence sub-system is configured to control movement of the unmanned aerial vehicle in the predetermined geographical surveillance area at a patrolling altitude, and control the unmanned manned aerial vehicle to a repellence altitude as a response to detecting the animal in the image data, the repellence altitude being less than the patrolling altitude.

The unmanned vehicle or the unmanned aerial vehicle are in some embodiments provided as autonomous vehicles which may patrol a predefined route(s), paths or areas without human interaction. Thus, also far located surveillance areas may be patrolled.

In one embodiment, the repellence sub-system is configured to determine moving direction and velocity of the detected animal based on the image data from the imaging device, control the unmanned vehicle or the unmanned aerial vehicle towards the detected animal, and initiate the species specific deterrence actions with the one or more deterrence devices.

In an alternative embodiment, the repellence sub-system is configured to store a pre-determined deterrence distance threshold value, determine moving direction and velocity of the detected animal based on the image data from the imaging device, control the unmanned vehicle or the unmanned aerial vehicle towards the detected animal, determine distance between the unmanned vehicle or the unmanned aerial vehicle and the detected animal, and initiate the species specific deterrence actions with the one or more deterrence devices when the determined distance is equal to or less than the pre-determined deterrence distance threshold value.

Accordingly, the deterrence sub-system is configured to control the unmanned vehicle or the unmanned aerial vehicle based on the detection of the animal in the surveillance area and towards the detected animal. Thus, the unmanned vehicle or the unmanned aerial vehicle is controlled to track detected animal approach the detected animal in order to intensify the deterrence actions carried out with the deterrence devices.

The present invention is further based on the idea of providing a method for repelling animals. the method being performed by a repellence system. The repellence system comprises an unmanned vehicle comprising an imaging device, one or more deterrence devices and repellence sub-system having one or more processors and memory storing instructions for execution by the one or more processors. The method comprising:
controlling the unmanned vehicle (10) in a predetermined geographical surveillance area for patrolling in the predetermined geographical surveillance area,
generating image data from the predetermined geographical surveillance area with the imaging device during controlling the unmanned vehicle in the predetermined geographical surveillance area,
detecting an animal in the image data with the repellence sub-system,
identifying animal species of the detected animal in the image data with the repellence sub-system,
defining species specific deterrence instructions based on the identified animal species with the repellence sub-system,
controlling the unmanned vehicle towards the detected and identified animal in the predetermined geographical surveillance area, and
carrying out species specific deterrence actions based on the defined species specific deterrence instructions with the deterrence device.

The method enables detecting and identifying animal species in the surveillance area and subjecting deterrence actions with the deterrence device to the detected animal such that the deterrence actions are specific to the identified animal species for efficient repellence. Further, the deterrence actions are directed to towards the animal as the unmanned vehicle is moved towards the animal. Thus, the animal is repelled to a desired direction and out of the predetermined geographical surveillance area.

In some embodiment, the method comprises controlling the movement of the unmanned vehicle towards the detected and identified animal in the predetermined geographical surveillance area, and initiating the species specific deterrence actions with the one or more deterrence devices during the movement of the unmanned vehicle towards the detected and identified animal. This enables repelling the animal to a desired direction.

In some other embodiment, the method comprises controlling the movement of the unmanned vehicle towards the detected and identified animal in the predetermined geographical surveillance area and measure distance between the unmanned vehicle and the animal, and initiating the species specific deterrence actions with the one or more deterrence devices when the distance between the unmanned vehicle and the animal equal or less than the predetermined deterrence distance threshold value.

In some embodiments, the method comprises determining location of the detected and identified animal in the predetermined geographical surveillance area in relation to the surveillance area border and controlling the movement of the unmanned vehicle towards the detected and identified animal in the predetermined geographical surveillance area in an approach direction in which the detected and identified animal is located between the unmanned vehicle and the surveillance area border for repelling the animal out of the predetermined geographical surveillance area.

The method comprises to determining the location of the detected animal based on the geographical location information of the predetermined geographical surveillance area, the vehicle location information and the image data from the imaging device.

In some embodiments, the method comprises determining location of the detected and identified animal in the predetermined geographical surveillance area in relation to the surveillance area border and controlling the movement of the unmanned vehicle towards the detected and identified animal and towards the surveillance area border in the predetermined geographical surveillance area in an approach direction in which the detected and identified animal is located between the unmanned vehicle and the surveillance area border for repelling the animal out of the predetermined geographical surveillance area.

In some embodiments, the method comprises determining moving direction of the detected and identified animal based on the image data from the imaging device, and controlling the unmanned vehicle towards the detected and identified based on the moving direction of the detected and identified animal in the predetermined geographical surveillance area.

In some other embodiments, the method comprises determining location and moving direction of the detected and identified animal based on the image data from the imaging device, and control the unmanned vehicle towards the detected and identified based on the location and moving direction of the detected and identified animal in the predetermined geographical surveillance area.

In some further embodiments, the method comprises determining location and moving direction of the detected and identified animal in the predetermined geographical surveillance area in relation to the surveillance area border based on the image data from the imaging device, and controlling the unmanned vehicle towards the detected and identified based on the location and moving direction of the detected and identified animal in the predetermined geographical surveillance area in the approach direction in which the detected and identified animal is located between the unmanned vehicle and the surveillance area border for repelling the animal out of the predetermined geographical surveillance area.

In some yet further embodiments, the method comprises determining location and moving direction of the detected and identified animal in the predetermined geographical surveillance area in relation to the surveillance area border based on the image data from the imaging device, and controlling the unmanned vehicle towards the detected and identified based on the location and moving direction of the detected and identified animal in the predetermined geographical surveillance area in the approach direction in which the detected and identified animal is located between the unmanned vehicle and the surveillance area border for repelling the animal out of the predetermined geographical surveillance area, and
redetermining the location and moving direction of the detected and identified animal in the predetermined geographical surveillance area in relation to the surveillance area border based on the image data from the imaging device, and adjusting the approach direction based on the redetermined location and moving direction of the detected and identified animal in the predetermined geographical surveillance area such the detected and identified animal is located between the unmanned vehicle and the surveillance area border for repelling the animal out of the predetermined geographical surveillance area.

The method comprises controlling the unmanned vehicle towards the animal and/or determining the approach direction based on the geographical location information of the predetermined geographical surveillance area, the vehicle location information and the image data from the imaging device.

In some embodiments, the unmanned vehicle is an unmanned aerial vehicle, such as a drone or plane.

In some other embodiments, the unmanned vehicle is an unmanned ground vehicle.

In some other embodiments, the method comprises controlling movement of the unmanned aerial vehicle in the predetermined geographical surveillance area at a patrolling altitude, and controlling the unmanned manned aerial vehicle to a repellence altitude as a response to detecting the animal in the image data, the repellence altitude being less than the patrolling altitude.

In one embodiment, the defining species specific deterrence instructions comprises storing two or more animal species profiles in an identification database of the repellence sub-system, each of the two or more animal species profiles comprising a species specific deterrence instructions species having a species specific ultrasound frequency value, and defining an animal species profile corresponding the identified animal species of detected animal, and the carrying out species specific deterrence actions comprises providing the species specific deterrence instructions of the defined animal species profile to a deterrence ultrasound device, the deterrence ultrasound device being capable of emitting ultrasound at different ultrasound frequencies, and emitting ultrasound with the deterrence ultrasound device, the emitted ultrasound having the species specific frequency value of the species specific deterrence instructions of the defined animal species profile.

Accordingly, species specific ultrasound frequency is used for repelling the animal such that the ultrasound frequency most suitable for different animal species is provided.

The method and embodiment of the method may be carried out with a repellence system as defined above.

Further, it should be noted that different embodiments of the invention as disclosed above may be combined in any suitable manner or as defined by the claims.

An advantage of the invention is that the repellence system and repellence method of the present invention provides increased repellence efficiency as deterrence actions are directed to the specific animal species which needs to be repelled and in direction enabling repelling the animal out of the predetermined geographical surveillance area. Further, the invention enables creating detailed repellence actions for different animal species. The invention provides automatic or autonomous repellence system and method which may operate without continuous maintenance and human labour.

### BRIEF DESCRIPTION OF THE DRAWINGS

The invention is described in detail by means of specific embodiments with reference to the enclosed drawings, in which

FIGS. 1 and 2 show schematically a repellence system comprising an unmanned aerial vehicle according to one embodiment of the present invention;

FIGS. 3 to 5 show schematically a repellence method utilizing the repellence system of FIGS. 1 and 2;

FIG. 6 shows a schematic representation of one embodiment of the repellence system according to the present invention; and

FIGS. 7 to 14 show schematically flow charts of different embodiments of the repellence method according to the present invention.

### DETAILED DESCRIPTION OF THE INVENTION

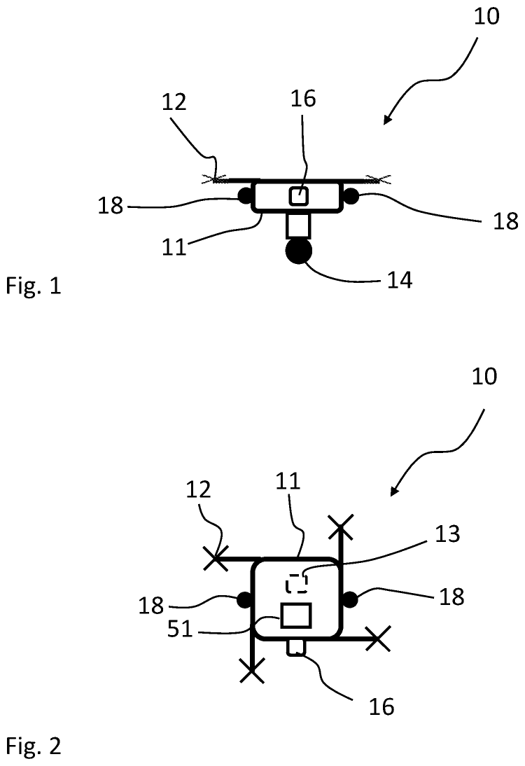

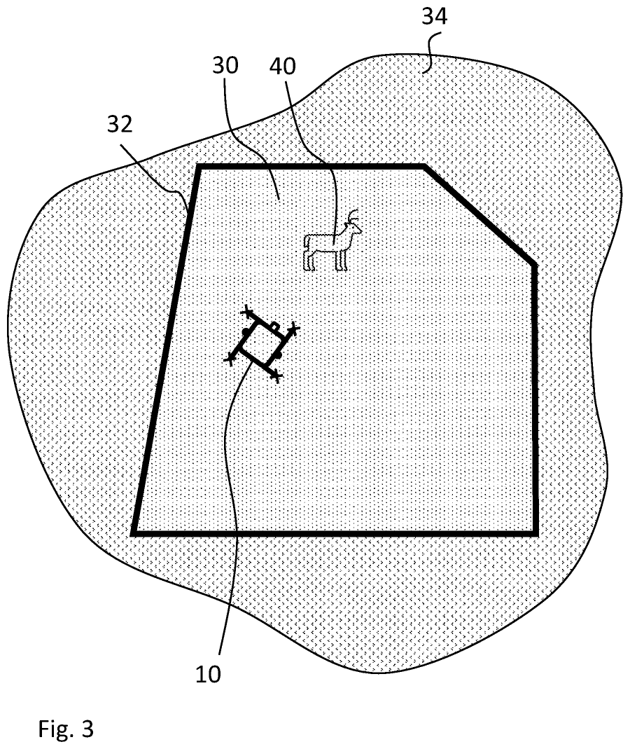

FIGS. 1 and 2 show one embodiment of the present invention in which a repellence system according to the present invention is provided to an unmanned aerial vehicle 10. FIG. 1 shows schematic side view of the unmanned aerial vehicle 10 and FIG. 2 shows a schematic top view of the unmanned aerial vehicle 10.

The unmanned aerial vehicle 10 can be any kind of known unmanned aerial vehicle. The unmanned aerial vehicle 10 comprises a body 11 and propellers 12 or the like propulsion elements arranged to move the unmanned aerial vehicle 10.

The unmanned aerial vehicle 10 further comprises a control unit 13, as shown in FIG. 2. The control unit 13 is configured to control the movement of the unmanned aerial vehicle 10. The control unit 10 is operatively connected to the propellers 12 and configured to control operation of the propellers 12 for moving the unmanned aerial vehicle 10. The control unit 13 comprises a control processor and a control memory (not shown). The control processor is configured to carry out control instructions stored in the control memory for controlling the unmanned aerial vehicle 10.

In some embodiments, the unmanned aerial vehicle 10 is an autonomous unmanned aerial vehicle 10 configured to move automatically based on the instruction stored to the control unit 13. The control unit 13 may further comprise a navigation module such as a GPS module (not shown) for controlling movement of the unmanned aerial vehicle 10 in autonomous manner. The control unit 13 may also comprise a communication module (not shown) such as 4G, 5G, radio frequency module or the like for receiving instructions for controlling the unmanned aerial vehicle 10. The communication module may also be configured to communicate with another unmanned aerial vehicle 10.

In an alternative embodiment, the unmanned aerial vehicle 10 is configured to be controllable with a remote controller (not shown). In this embodiment, the control unit 13 comprise a communication module (not shown) such as 4G, 5G, radio frequency module or the like for receiving control instructions from the remote controller for controlling the unmanned aerial vehicle 10. In this embodiment, the unmanned aerial vehicle 10 may be human controlled.

It should be noted that the present invention is not restricted to any specific type of unmanned aerial vehicle 10, but any suitable unmanned aerial vehicle 10 may be used for carrying out the present invention.

The repellence system according to the present invention is provided to the unmanned aerial vehicle 10. The repellence system comprises an imaging device 14 provided to the unmanned aerial vehicle 10. The imaging device 14 is configured to generate image data from a surveillance area. The generated image data comprises one or more separate images taken with the imaging device 14 or a video taken with the imaging device 14. The video comprises several separate image frames.

The imaging device 14 is provided to the to the unmanned aerial vehicle 10 as a fixed imaging device 14. The fixed imaging device 14 is arranged stationary to the unmanned aerial vehicle 10.

In an alternative embodiment, the imaging device 14 is provided to the unmanned aerial vehicle 10 as a movable or turnable imaging device 14. The movable imaging device 14 is arranged to the unmanned aerial vehicle 10 movable or turnable in relation to the unmanned aerial vehicle 10.

The repellence system further comprises a repellence sound device or devices 16 arranged to generate deterrence sound or sounds. The deterrence sound device 16 is provided to the unmanned aerial vehicle 10.

The deterrence sound device 16 may comprise a speaker or a sound source or the like sound generator arranged to emit sound or noise for repelling animals.

In some embodiments, the deterrence sound device 16 is configured to generate and emit different sounds at different sound volumes and/or sound frequencies. Accordingly, the repellence system is configured to adjust the sound volume and/or sound frequencies generated and emitted by the deterrence sound device 16.

The repellence system further comprises a repellence ultrasound device or devices 16 arranged to generate deterrence ultrasound or ultrasounds. The deterrence ultrasound device 16 is provided to the unmanned aerial vehicle 10.

The deterrence ultrasound device 16 may comprise an ultrasound source or the like ultrasound generator arranged to emit ultrasound for repelling animals.

In some embodiments, the deterrence ultrasound device 16 is configured to generate and emit ultrasound at different ultrasound frequencies. Accordingly, the repellence system is configured to adjust the ultrasound frequencies generated and emitted by the deterrence ultrasound device 16.

The repellence system may comprise one or more deterrence sound devices 16 or one or more deterrence ultrasound devices 16 for generating and emitting sound or ultrasound.

Alternatively, the repellence system may comprise one or more deterrence sound devices 16 and one or more deterrence ultrasound devices 16 for generating and emitting both sound and ultrasound. The repellence system may be configured to generate and emit sound and ultrasound simultaneously or at different times.

The repellence system further comprises a repellence light device or devices 18 arranged to generate deterrence light. The deterrence light device 18 is provided to the unmanned aerial vehicle 10.

The deterrence light device 18 may comprise a light source or the like illumination device arranged to generate and emit visible light.

The deterrence light device 18 may comprise for example one or more LED (light emitting diode) elements or laser elements for generating and emitting deterrence light.

In some embodiments, the deterrence light device 18 is configured to generate and emit different lights at different brightness and/or at different colours. Further, the deterrence light device 18 is configured to generate and emit continuous light or blinking light. Accordingly, the repellence system is configured to adjust the light brightness, colour and emitting pattern by the deterrence light device 16.

The repellence system comprises both deterrence light devices 18 and deterrence sound devices 16, or deterrence light devices 18, deterrence sound devices 16 and deterrence ultrasound devices 16 provided to the unmanned aerial vehicle 10.

In an alternative embodiment, the repellence system comprises only deterrence light devices, or deterrence sound devices or deterrence ultrasound devices.

The repellence system further comprises a repellence sub-system 51 having one or more processors and memory storing instructions for execution by the one or more processors.

The repellence sub-system 51 is provided to the unmanned aerial vehicle 10, as shown in FIG. 2. The imaging device 14 and the one or more deterrence devices 16, 18 are connected or operatively connected to the repellence sub-system 51.

In an alternative embodiment, the repellence sub-system 51 is provided to an external identification server (not shown) and the unmanned aerial vehicle 10 is provided with a repellence system communication module (not shown) configured to provide communication connection with the external server and the repellence sub-system 51 in the external identification sever. The repellence system communication module being configured to transmit and receive data, or exchange data, with the external identification server and the repellence sub-system 51. The imaging device 14 and the one or more deterrence devices 16, 18 are connected or operatively connected to the repellence system communication module.

The repellence sub-system 51 is configured to receive image data from the imaging device 14. The repellence sub-system 51 is further configured to detect an animal or animals in the image data and identify animal species of the detected animal or animals in the image data. The repellence sub-system 51 is also configured to generate species specific deterrence instructions based on the identified animal species in the image, and to provide species specific deterrence instructions to the one or more deterrence devices 16, 18 based on the identified animal species.

The species specific deterrence instructions comprise instructions for carrying out species specific deterrence actions with the deterrence device 16, 18. The species specific deterrence instructions are specific to the identified animal species. Thus, the generated species specific deterrence instructions and thus performed species specific deterrence actions are different for different animal species. This provides efficient repellence of animals.

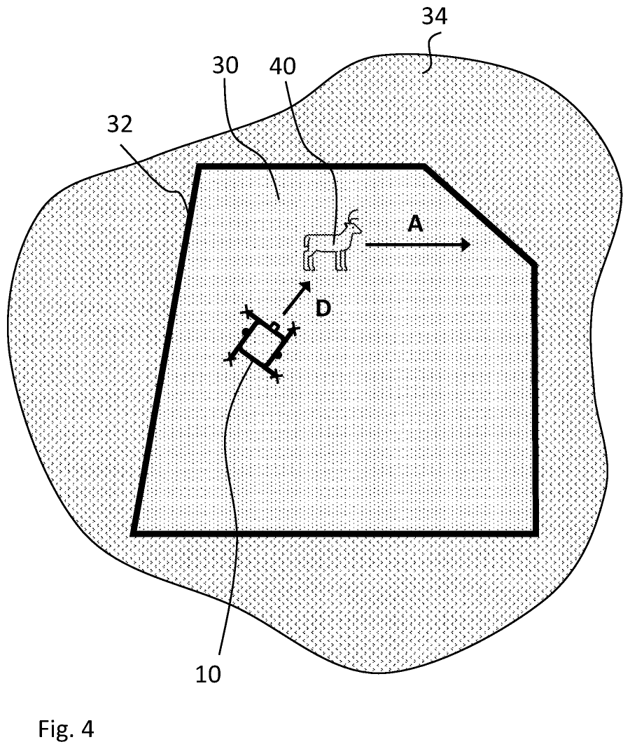

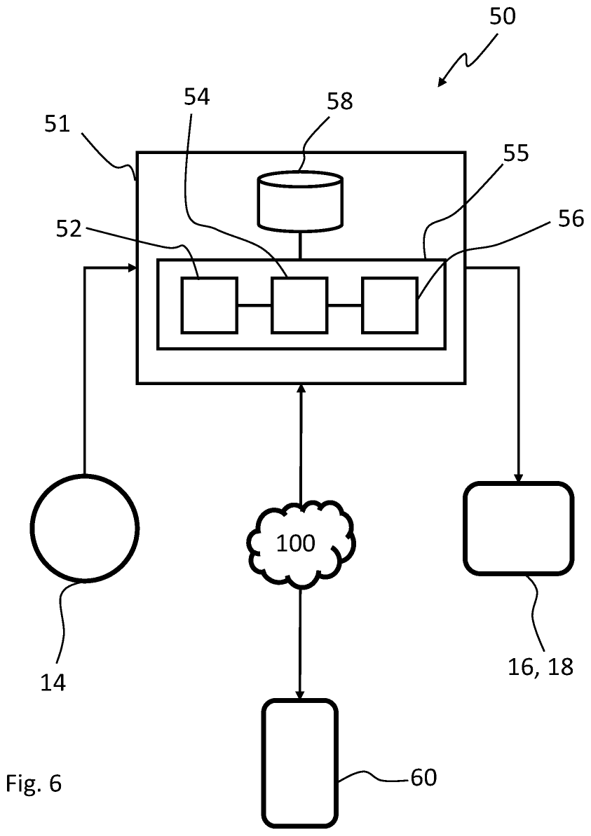

FIGS. 3 to 5 show one embodiment, in which the repellence system is arranged in connection with or to the unmanned aerial vehicle 10. Thus, FIGS. 3 to 5 schematically show utilization of the repellence system with the unmanned aerial vehicle 10 for repelling animals.

It should be noted, that the unmanned aerial vehicle 10 may also be replaced with an unmanned ground vehicle.

As shown in FIG. 3, the unmanned aerial vehicle 10 patrols a predetermined geographical surveillance area 30. When the unmanned aerial vehicle 10 is an autonomous unmanned aerial vehicle 10, the unmanned aerial vehicle 10 is configured to move a pre-determined route in the surveillance area 30 or move according to control instructions stored or provided to the control unit 13.

The predetermined geographical surveillance area 30 is determined by location coordinates stored in the repellence sub-system 51. Thus, geographical location information of the predetermined geographical surveillance area 30 is stored to the repellence sub-system 51.

The geographical location information of the predetermined geographical surveillance area 30 may be determined with global navigation satellite system (GNSS) coordinates, such as Global Navigation System (GPS) coordinates.

The predetermined geographical surveillance area 30 comprises a surveillance area border 32 within which the predetermined geographical surveillance area 30 is provided.

The surveillance area border 32 is determined with the GNSS coordinates.

The surveillance area border 32 is configured to generate a geofence in the repellence sub-system 51 for controlling the movement of the unmanned vehicle 10 and determining the predetermined geographical surveillance area 30.

The unmanned vehicle 10 is configured to patrol in the predetermined geographical surveillance area according to the control instructions provide by the repellence sub-system.

The unmanned vehicle 10 is provided with a GNSS receiver, such as GPS receiver, configured to receive GNSS signals from GNSS satellites, such as GPS satellites. The repellence sub-system is configured determine vehicle location information of the unmanned vehicle 10 based on the GNSS signals received in the GNSS receiver of the unmanned vehicle 10.

Accordingly, the repellence sub-system is configured to control the movement of the unmanned vehicle 10 in the predetermined geographical surveillance area 30 based on the geographical location information of the predetermined geographical surveillance area 30, and the vehicle location information of the unmanned vehicle.

The unmanned aerial vehicle 10 generates image data from the surveillance area 30 with the imaging device 14 during the patrolling. The image data is processed with the repellence sub-system 51 continuously and in real-time for detecting and identifying animals in the surveillance area 30.

Accordingly, predetermined geographical surveillance area 30 may be any land or sea area. The predetermined geographical surveillance area 30 has the perimeter or border 32 inside which is the predetermined geographical surveillance area 30. Outside the border 32 is surrounding area 34, which is so called free area where the unmanned aerial vehicle 10 does not patrol.

The object of the repellence system of the present invention is to repel animals detected and identified inside surveillance area 30 out of the predetermined geographical surveillance area 30 to the free area 34 outside the surveillance area 30.

It should be noted that in the present invention the animals detected inside predetermined geographical surveillance area 30 are identified to identify the species of the animals. Identifying the species of the animal is important such that effective deterrence actions may be used. The effective deterrence actions are specific to the identified animal species.

As shown in FIG. 3, the repellence system provided to the unmanned aerial vehicle 10 detects an animal 40 inside the surveillance area 30. The detection of the animal 40 is carried out by inputting image data generated by the imaging device 14 to the repellence sub-system 51. The repellence sub-system 51 is configured to detect animals 40 in the image data and to further identify species of the detected animals 40.

When the animal 40 is detected by the repellence sub-system 51 in the image data of the imaging device 14, the repellence sub-system 51 identifies species of the detected animal 40. The repellence sub-system 51 comprises deterrence instructions for different animal species. Thus, after identification of the animal species of the detected animal 40 with the repellence sub-system 51, the repellence sub-system 51 is configured to generate deterrence instructions specific to the identified animal species. The repellence sub-system 51 is further configured to provide the species specific deterrence instructions to the one or more deterrence devices 16, 18 and the deterrence devices 16, 18 are configured to carry out species specific deterrence actions based on the species specific deterrence instructions.

In certain situations, the repellence sub-system 51 is unable to identify the detected animal 40 in the image data. This maybe due to great distance between the imaging device 14 and the detected animal 40 or due to for example weather conditions, such as rain or fog. In this case the repellence sub-system 51 is configured to generate control instructions for controlling the movement of the unmanned aerial vehicle 10. The repellence sub-system 51 is configured to provide the control instructions to the control unit 13 of the unmanned aerial vehicle 10 for automatically controlling the movement of the unmanned aerial vehicle 10. Alternatively, when the unmanned aerial vehicle 10 is not an autonomous unmanned aerial vehicle 10, the repellence sub-system 51 provides the control instructions to a user of the unmanned aerial vehicle 10 or to remote controller of the unmanned aerial vehicle 10.

The repellence sub-system 51 is configured to generate control instructions controlling the unmanned aerial vehicle 10 towards the detected animal 40, as shown with arrow D in FIG. 3, such that the distance between the animal 40 and the unmanned aerial vehicle 10 or the imaging device 14 decreases. The imaging device 14 is configured to generate image data continuously and the repellence sub-system 51 is configured to receive the image data from the imaging device 14 continuously. The repellence sub-system 51 is configured to continuously detect the animal 40 in the image data and when the distance between the imaging device 14 and the animal 40 is decreased, or decreased enough, the repellence sub-system 51 is able to identify the species of the detected animal 40.

The output from the detection algorithm or identification algorithm may be provided as input to the control unit 13 of the unmanned aerial vehicle 10. The control unit 13 may be further provided with a control algorithm for controlling the movement of the unmanned aerial vehicle 10. The output from the detection algorithm or identification algorithm may be provided as input to the control algorithm of the control unit 13 of the unmanned aerial vehicle 10.

The repellence sub-system 51 is configured to generate or update the control instructions based on each image received or processed with repellence sub-system 51. Thus, the control instructions are configured to control the unmanned aerial vehicle 10 continuously towards the animal or to follow animal 40 even when the animal 40 is moving.

The repellence sub-system 51 is configured to process the image data continuously such that each received image or image frame is processed to detect and identify the animal 40. Thus, the repellence sub-system 51 is configured to generate or update the control instructions based on each image or each frame received in repellence sub-system 51.

The control unit 13 is configured to control the unmanned aerial vehicle 10 to fly at a height of 2 to 100 m from the ground.

The repellence sub-system 51 is configured to detect animal 40 from a distance of 0 to 400 m, ore 0 to 300 m, or 0 to 200 m depending on the used imaging device 14 and the weather conditions in the surveillance area.

The repellence sub-system 51 is configured to control the unmanned aerial vehicle 10 towards the detected animal 40, and initiate the species specific deterrence actions with the deterrence devices.

Usually, the repellence sub-system 51 is configured to control the unmanned aerial vehicle 10 towards the detected animal 40 to a deterrence distance from animal 40. When the deterrence distance is reached, the repellence sub-system 51 is configured to initiate the species specific deterrence actions with deterrence devices 16, 18 by providing the deterrence instructions to the deterrence devices 16, 18.

The deterrence distance may also be pre-determined and further it may be specific to the animal species. Thus, the repellence sub-system 51 is configured to store a pre-determined deterrence distance threshold value, control the unmanned vehicle 10 towards the detected animal 40, determine distance between the unmanned vehicle or the unmanned aerial vehicle 10 and the detected animal 40 continuously as the unmanned aerial vehicle 10 is controlled towards the detected animal 40, and initiate the species specific deterrence actions with the one or more deterrence devices 16, 18 when the determined distance is equal to or less than the pre-determined deterrence distance threshold value.

Determining the distance between the unmanned vehicle or the unmanned aerial vehicle 10 and the detected animal 40 is carried out from the image data with the repellence sub-system 51. Therefore, the between the unmanned vehicle or the unmanned aerial vehicle 10 and the detected animal 40 is determined from images or from each image or each image frame.

Alternatively, the unmanned aerial vehicle 10 is provided with a distance measurement device (not shown), such as a laser measurement device, generating distance measurement data and being connected to or operatively connected to the repellence sub-system 51. Further alternatively, the imaging device 14 is configured to generate distance measurement data.

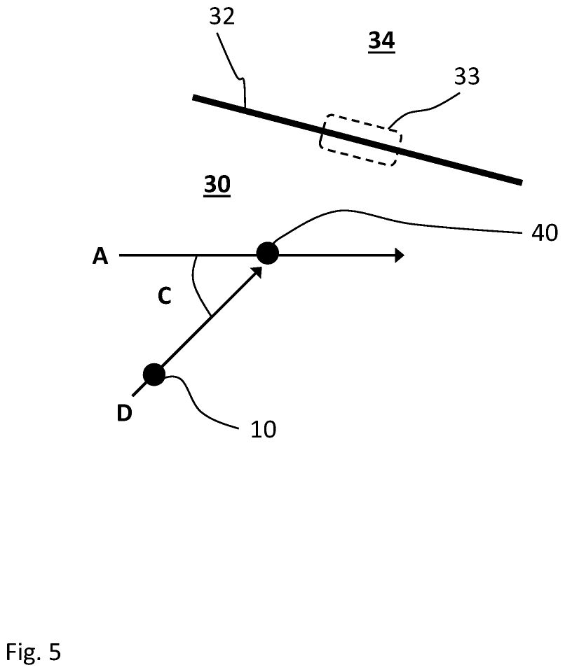

FIG. 4 shows schematically further preferred controlling of the movement of the unmanned aerial vehicle 10 upon detecting the animal in the surveillance area 30.

The repellence sub-system 51 is configured to generate control instructions to control the unmanned aerial vehicle 10 towards the detected animal in an approach direction D. The repellence sub-system 51 is configured to generate control instructions to control the unmanned aerial vehicle 10 towards the detected animal 40 in the approach direction D in which the detected animal 40 is placed between the unmanned aerial vehicle 10 and a periphery location 33 on the periphery 32 of the surveillance area 30. The periphery location 33 being predetermined target location on the periphery 32 via which the animal 40 is repelled out of the surveillance area 30. Alternatively, the periphery location 3 is the location of the periphery 32 closest to the detected animal 40.

The animal 40 may be moving in an animal moving direction A and possibly also the moving velocity, as shown in FIG. 4. The repellence sub-system 51 is configured to determine the animal moving direction A from the image data of the imaging device 14.

The repellence sub-system 51 is configured to determine animal moving direction A and possibly also the moving velocity based on the successive images or image frames in the image data. Thus, the animal moving direction and possibly also moving velocity is updated continuously.

The repellence sub-system 51 is configured to generate control instructions for controlling the unmanned aerial vehicle 10 towards the detected animal 40 in the approach direction D. The repellence sub-system 51 is configured to control the unmanned aerial vehicle 10 towards the detected animal 40 in the approach direction D such that an angle C between the animal moving direction A and the approach direction is less than 90 degrees. Preferably, the repellence sub-system 51 is configured to control the unmanned aerial vehicle 10 towards the detected animal 40 in the approach direction D such that an angle C between the animal moving direction A and the approach direction is less than 90 degrees, or less than 60 degrees, or between 30 to 60 degrees, and more preferably 45 degrees.

It should be noted that the embodiment of FIGS. 1 to 4 is described in connection with an unmanned aerial vehicle 10, but the repellence system may also be provided in connection with any other unmanned vehicle such as an unmanned ground vehicle.

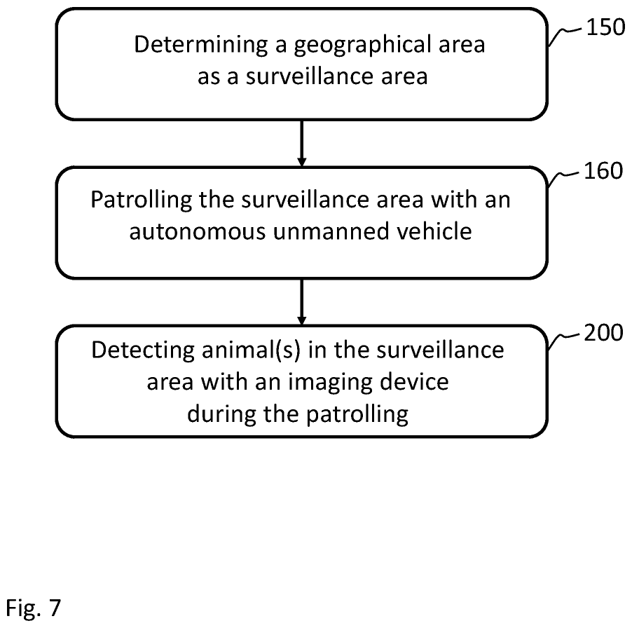

FIGS. 6 to 14 disclose operation of the repellence system 50 of the present invention. The disclosed operation is common for all embodiments o the present invention.

FIG. 6 shows schematically the repellence system 50 according to the present invention. The repellence system 50 comprises the repellence sub-system 51 having repellence unit 55. The repellence unit 55 comprises one or more processors 52 and a memory 54 storing instructions 56 for execution by the one or more processors 52.

The imaging device 14 is connected to the repellence sub-system 51 and the repellence sub-system 51 is configured to receive image data from the imaging device 14. The repellence sub-system 51, or the repellence unit 55, is configured to detect an animal in the image data, identify animal species of the detected animal in the image data, and provide species specific deterrence instructions to the one or more deterrence devices 16, 18 based on the identified animal species for carrying out species specific deterrence actions with the deterrence device 16, 18. The species specific deterrence instructions are specific to the identified animal species.

The deterrence device 16, 18 connected to the repellence sub-system 51 and configured to receive the species specific deterrence instructions from the repellence sub-system 51.

The repellence system 50 further comprises a user device 60 connected to the repellence sub-system 51 over a communication network 100. The user device 60 may be a computer, mobile user device, mobile phone, tablet computer or the any other known user device. The communication network 100 may be Wi-Fi-network, internet, 4G, 5G, Bluetooth, radio frequency network or any other known wireless communication network or a communication line.

The repellence sub-system 51 is configured to generate a notification or alarm upon detection of an animal in the surveillance area 30 and/or upon detection and identification of an animal in the surveillance area 30, and providing the alarm or notification to the user device 60 over the communication network 100.

The repellence sub-system 51 further comprises an identification database 58 having two or more animal species profiles stored in the identification database 58. Each of the animal species profiles being specific to one animal species. Each animal species profile comprises the species specific deterrence instructions specific to the animal species of the animal species profile.

The identification subsystem 51 is configured to define an animal species profile corresponding the identified animal species of the detected animal 40 based on the identification, and utilize or apply the species specific deterrence instructions of the defined animal species and provide the species specific deterrence instructions to the one or more deterrence device 16, 18 arranged to carry out species specific deterrence actions based on the species specific deterrence instructions.

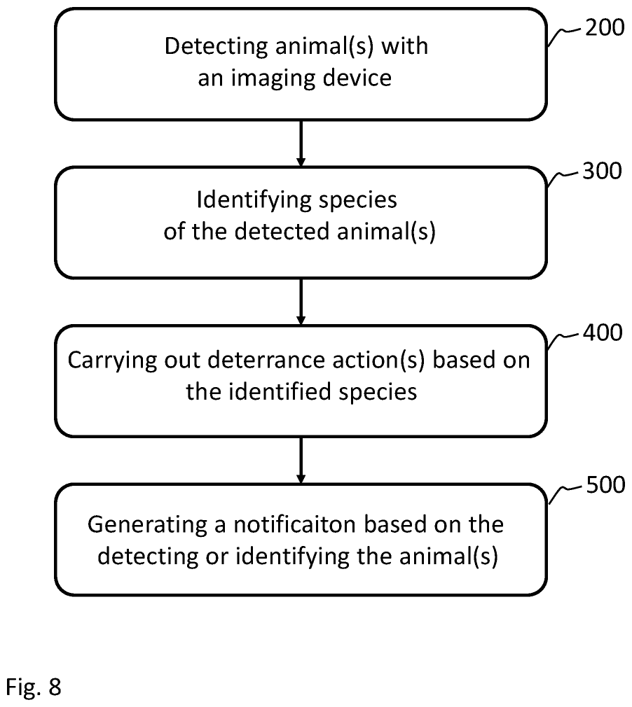

FIG. 7 shows general steps of the method of the present invention. IN step 150 a geographical area is determined as the predetermined geographical surface area 30. In step 160, the autonomous unmanned vehicle 160 patrols in the predetermined geographical surface area 30 and in step 200 an animal is detected in the predetermined geographical surface area 30 with the imaging device of the unmanned vehicle 10 during the patrolling.

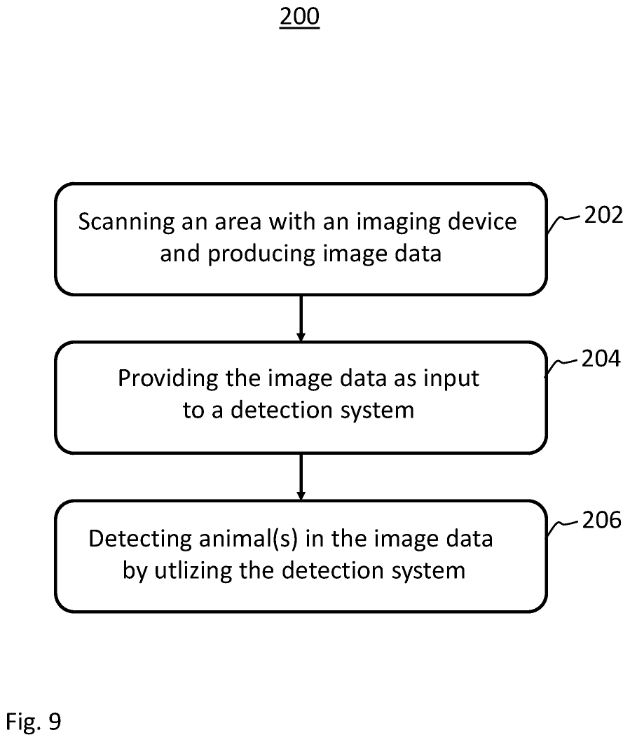

FIG. 8 shows a general flow chart of a repellence method according to the present invention carried out with the repellence system 50. The method comprises generating image data from a surveillance area with the imaging device 14. The repellence sub-system 51 is configured to receive the image data from the imaging device 14.

Then, in step 200 the repellence sub-system 51 is configured to detect an animal in the image data with the repellence sub-system 51, and further to animal species of the detected animal 40 in the image data with the repellence sub-system 51 in step 300.

It should be noted that the steps 200 and 300 may be carried out simultaneously or successively.

In step 400, the repellence sub-system 51 is configured to generate the species specific deterrence instructions based on the identification of the detected animal in step 300. The species specific deterrence instructions are further provided to the one or more deterrence devices 16, 18 in step 400. Step 400 further comprises carrying out deterrence actions with the one or more deterrence devices 16, 18 based on the species specific deterrence instructions.

The method further comprises step 500 in which the repellence sub-system 51 is configured to generate a notification or alarm based on the detection and/or identification of the animal with the repellence sub-system 51. The step 500 further comprises providing the alarm or notification to the user device 60 over the communication network 100, as disclosed on connection with FIG. 8.

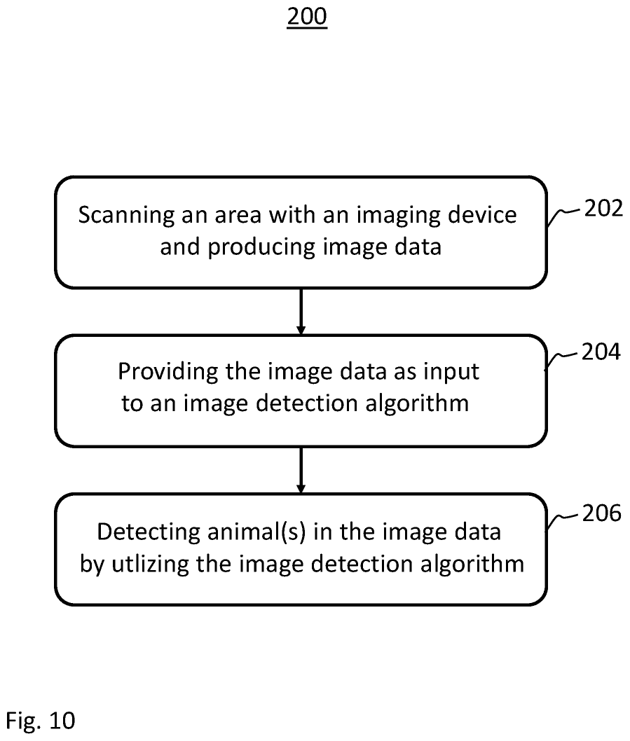

FIG. 9 shows one embodiment of step 200. The step 200 comprises scanning the surveillance area 30, 31 with the imaging device and producing image data in step 202. The produced image data is provided as input data to the repellence sub-system 51 in step 204. The repellence sub-system 51 is configured to detect animal(s) in the inputted image data in step 206.

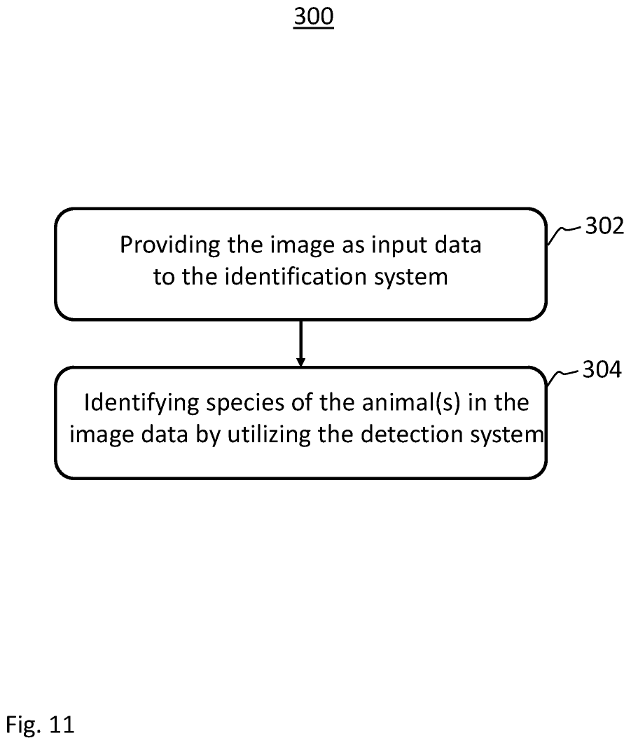

FIG. 10 shows another embodiment of step 200. The step 200 comprises scanning the surveillance area 30 with the imaging device and producing image data in step 202. The produced image data is provided as input data to an image detection algorithm or computer vision algorithm in the repellence sub-system 51 in step 204. The repellence sub-system 51 and the image detection algorithm or the computer vision algorithm is configured to detect animal(s) in the inputted image data in step 206.

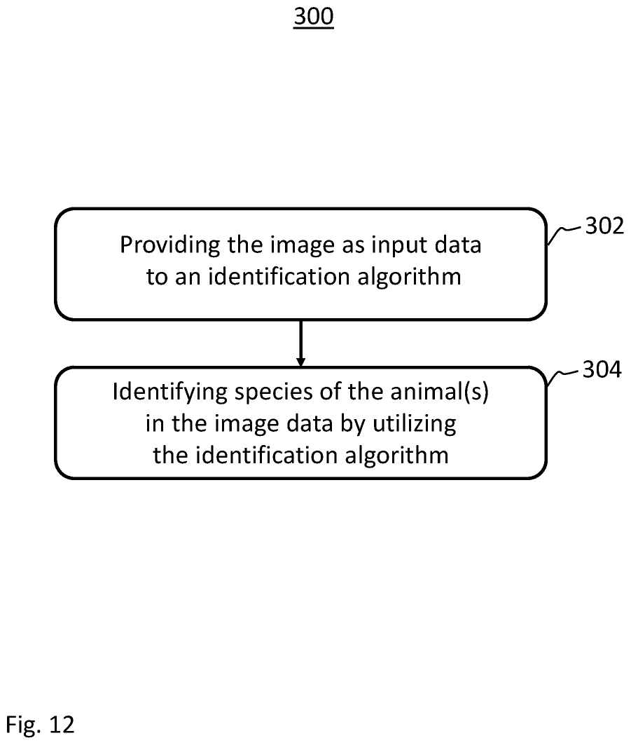

FIG. 11 shows one embodiment of step 300. The step 300 comprises inputting the produced image data as input data to the repellence sub-system 51 in step 302. The repellence sub-system 51 is configured to identify animal species of the detected animal in the inputted image data in step 304.

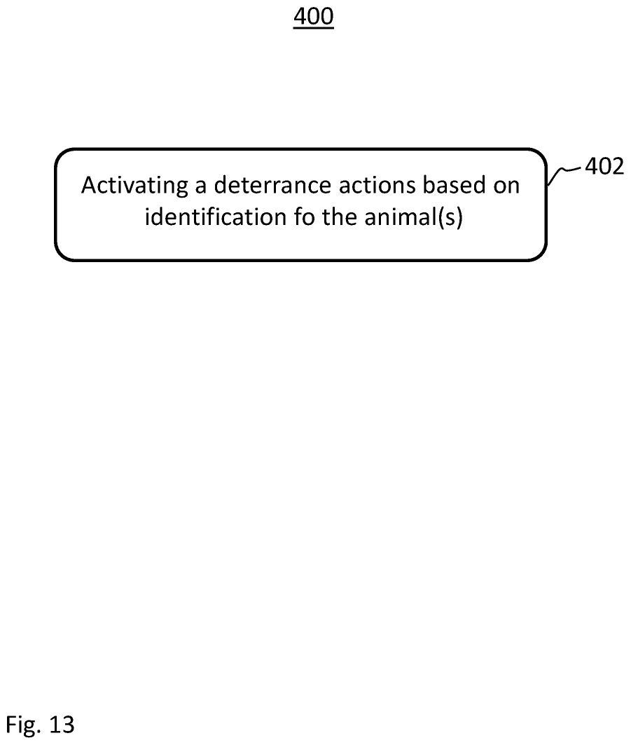

FIG. 12 shows another embodiment of step 300. The step 300 comprises inputting the produced image data as input data to the image detection algorithm or computer vision algorithm in the repellence sub-system 51 in step 302. The repellence sub-system 51 and the image detection algorithm or the computer vision algorithm is configured to identify animal species of the detected animal in the inputted image data in step 304.

The image detection algorithms or computer vision algorithms in steps 200 and 300 are different algorithms.

Alternatively, the image detection algorithms or computer vision algorithms in steps 200 and 300 are one combined algorithm configured to both detect animals in the image data and identify animal species of the detected animals in the image data. In this embodiment, the steps 200 and 300 are combined.

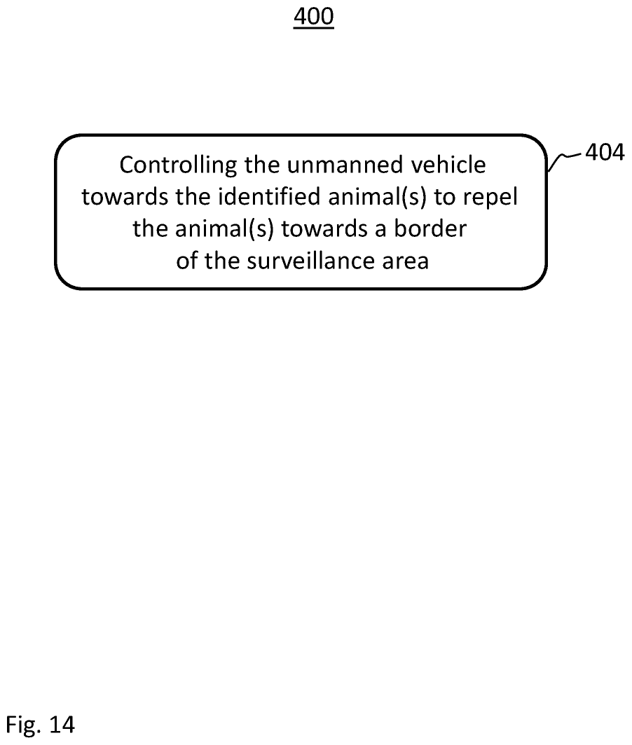

FIG. 13 shows one embodiment of step 400. The step 400 comprises activating the one or more deterrence devices 16, 18 based on the identification of the animal species of the detected animal in step 402.

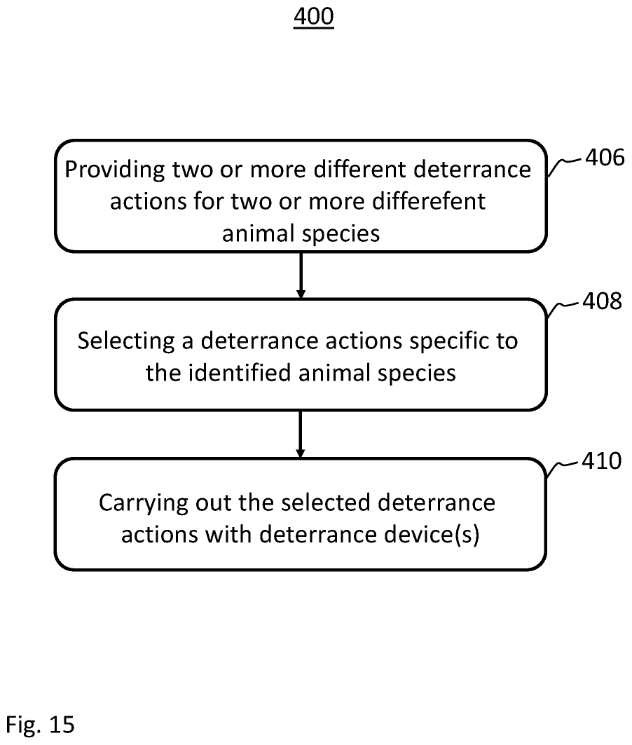

FIG. 14 shows one embodiment of step 400. The step 400 comprises controlling the unmanned vehicle 10 towards the detected animal 40 to repel the animal 40 towards the border 32 of the predetermined geographical surveillance area 30 in step 404.

FIG. 15 shows another embodiment of step 400. The step 400 comprises providing two or more different deterrence instructions or deterrence actions for two or more different animal species instep 406. The different deterrence instructions or deterrence actions are provided to the animal species profiles stored in the identification database 58. The step 400 further comprises selecting deterrence instructions or deterrence actions corresponding the identified animal species in step 408. Thee step 408 may comprise selecting an animal species profile corresponding the identified animal species. The step 400 further comprises providing the deterrence instructions of the identified animal species to the one or more deterrence devices 16, 18, and carrying out deterrence actions with the one or more deterrence devices 16, 18 based on the species specific deterrence instructions.

The invention has been described above with reference to the examples shown in the figures. However, the invention is in no way restricted to the above examples but may vary within the scope of the claims.

1.-23. (canceled)

24. A repellence system for repelling animals, wherein the repellence system comprises:
an unmanned vehicle, comprising an imaging device arranged to generate image data, and one or more deterrence devices arranged to carry out deterrence actions for repelling animals; and
a repellence sub-system having one or more processors and memory storing instructions for execution by the one or more processors, the repellence sub-system being configured to
a) control movement of the unmanned vehicle in a predetermined geographical surveillance area having a surveillance area border defining the predetermined geographical surveillance area,
b) receive image data of the predetermined geographical surveillance area from the imaging device during movement of the unmanned vehicle in the predetermined geographical surveillance area,
c) detect an animal in the image data with the repellence sub-system,
d) identify animal species of the detected animal in the image data with the repellence sub-system,
e) control the unmanned vehicle towards the detected and identified animal in the predetermined geographical surveillance area, and
f) provide species specific deterrence instructions to the one or more deterrence devices based on the identified animal species for carrying out species specific deterrence actions with the deterrence device, the species specific deterrence instructions being specific to the identified animal species.

25. The repellence system according to claim 24, wherein the repellence sub-system is configured to:
a) control movement of the unmanned vehicle in the predetermined geographical surveillance area in an autonomous manner; or
a) control movement of the unmanned vehicle in the predetermined geographical surveillance area along a predetermined surveillance path; or
a) maintain geographical location information of the predetermined geographical surveillance area and control movement of the unmanned vehicle in the predetermined geographical surveillance area; or
a) maintain geographical location information of the predetermined geographical surveillance area and control movement of the unmanned vehicle in the predetermined geographical surveillance area in an autonomous manner or along a predetermined surveillance path.

26. The repellence system according to claim 24, wherein the repellence sub-system is configured to:
c) detect the animal in the image data with a computer vision algorithm, the computer vision algorithm being trained to detect animal in the image data; or
c) input the image data as first input image data to a computer vision algorithm, and detect the animal in the first input image data with the computer vision algorithm, the computer vision algorithm being trained to detect animals in the first input image data; or
c) input the video image data as first input image data to a computer vision algorithm, and detect the animal in the first input image data with the computer vision algorithm by processing each frame of the video image data with the computer vision algorithm to detected the animal, the computer vision algorithm being trained to detect animals in the first input image data.

27. The repellence system according to claim 24, wherein the repellence sub-system is configured to:
d) identify the animal species of the detected animal in the image data with an image identification algorithm, the image identification algorithm being trained to identify different animals species from the image data; or
d) input the image data as second input image data to an image identification algorithm, and identify animal species of the detected animal in the second input image data with the image identification algorithm, the image identification algorithm being trained to identify different animal species from the second input image data; or
d) inputting the video image data as second input image data to an image identification algorithm, and identify animal species of the animal in the second input image data with the image identification algorithm by processing one or more frames of the video image data with the image identification algorithm to identify animal species of the animal, the image identification algorithm being trained to identify different animal species from the second input image data.

28. The repellence system according to claim 24, wherein the repellence sub-system is configured to:
c) detect the animal and identify animal species of the detected animal in the image data with a computer vision algorithm, the computer vision algorithm being trained to detect animals and identify animal species in the image data; or
c) input the image data as first input image data to a computer vision algorithm, and detect the animal and identify animal species of the detected animal in the first input image data with the computer vision algorithm, the computer vision algorithm being trained to detect animals and identify animal species in the first input image data; or
c) input the video image data as first input image data to a computer vision algorithm, and detect the animal and identify animal species of the detected animal in the first input image data with the computer vision algorithm by processing each frame of the video image data with the computer vision algorithm to detected the animal, the computer vision algorithm being trained to detect animals and identify animal species in the first input image data.

29. The repellence system according to claim 24, wherein the one or more deterrence devices comprise:
a deterrence sound device arranged to generate species specific deterrence sound action as the deterrence action in response to the species specific deterrence instructions; or
a deterrence ultrasound device arranged to generate species specific deterrence ultrasound action as the deterrence action in response to the species specific deterrence instructions; or
a deterrence light device arranged to generate species specific deterrence light action as the deterrence action in response to the species specific deterrence instructions; or
a deterrence sound device arranged to generate species specific deterrence sound action and a deterrence light device arranged to generate species specific deterrence light action as the deterrence actions in response to the species specific deterrence instructions; or
a deterrence ultrasound device arranged to generate species specific deterrence ultrasound action and a deterrence light device arranged to generate species specific deterrence light action as the deterrence actions in response to the species specific deterrence instructions; or
a deterrence ultrasound device arranged to generate species specific deterrence ultrasound action and a deterrence sound device arranged to generate species specific deterrence sound action as the deterrence actions in response to the species specific deterrence instructions.

30. The repellence system according to claim 29, wherein:
f) the repellence sub-system is configured to generate species specific deterrence instructions based on the identification of the animal species of the detected animal, and provide the generated species specific deterrence instructions to the one or more deterrence devices; or
f) each of the two or more animal species profiles comprise species specific deterrence instructions specific to the respective animal species, the species specific deterrence instructions comprising instructions to carry out species specific deterrence actions with the one or more deterrence devices specific to the animal species, the repellence sub-system being configured to carry out the species specific deterrence actions based on the species specific deterrence instructions of the animal species profile corresponding the identified animal species of the detected animal, or
provide the species specific deterrence instructions of the animal species profile corresponding the identified animal species of the detected animal to the one or more deterrence devices, and
operate the one or more deterrence devices based on the species specific deterrence instructions corresponding the animal species profile of the identified animal species o the detected animal to generate species specific deterrence actions with the one or more deterrence devices.

31. The repellence system according to claim 24, wherein the one or more deterrence devices comprise the deterrence ultrasound device, the repellence sub-system being configured to:
carry out the species specific deterrence actions by utilizing a species specific ultrasound frequency value in the deterrence ultrasound device based on the identified animal species of the detected animal, the species specific deterrence instructions comprising the species specific ultrasound frequency value; or
generate species specific deterrence instructions comprising a species specific ultrasound frequency value for the deterrence ultrasound device based on the identified animal species of the detected animal,
provide the generated species specific deterrence instructions to the deterrence ultrasound device, and
operate the deterrence ultrasound device with the species specific ultrasound frequency value of the species specific deterrence instructions; or
each of the two or more animal species profiles comprise species specific deterrence instructions specific to the respective animal species, the species specific deterrence instructions comprising species specific ultrasound frequency value to be utilized by the deterrence ultrasound device, and the repellence sub-system being configured to carry out the species specific deterrence actions by utilizing the species specific ultrasound frequency value in the deterrence ultrasound device based on the species specific deterrence instructions of the animal species profile corresponding the identified animal species of the detected animal, or
provide the species specific deterrence instructions of the animal species profile corresponding the identified animal species of the detected animal to the deterrence ultrasound devices, the species specific deterrence instructions comprising a species specific ultrasound frequency value, and
operate the deterrence ultrasound device with the species specific ultrasound frequency value of the species specific deterrence instructions of animal species profile corresponding the identified animal species of the detected animal.

32. The repellence system according to claim 24, wherein the repellence sub-system is configured to:
e) control movement of the unmanned vehicle towards the detected and identified animal in the predetermined geographical surveillance area, and
g) initiate the species specific deterrence actions with the one or more deterrence devices during the movement of the unmanned vehicle towards the detected and identified animal; or
e) control movement of the unmanned vehicle towards the detected and identified animal in the predetermined geographical surveillance area and measure distance between the unmanned vehicle and the animal, and
g) initiate the species specific deterrence actions with the one or more deterrence devices when the distance between the unmanned vehicle and the animal equal or less than a predetermined deterrence distance threshold value.

33. The repellence system according to claim 24, wherein the repellence sub-system is configured to:
e) determine location of the detected and identified animal in the predetermined geographical surveillance area in relation to the surveillance area border and control movement of the unmanned vehicle towards the detected and identified animal in the predetermined geographical surveillance area in an approach direction (D) in which the detected and identified animal is located between the unmanned vehicle and the surveillance area border for repelling the animal out of the predetermined geographical surveillance area; or
e) determine location of the detected and identified animal in the predetermined geographical surveillance area in relation to the surveillance area border and control movement of the unmanned vehicle towards the detected and identified animal and towards the surveillance area border in the predetermined geographical surveillance area in an approach direction (D) in which the detected and identified animal is located between the unmanned vehicle and the surveillance area border for repelling the animal out of the predetermined geographical surveillance area.

34. The repellence system according to claim 33, wherein the repellence sub-system is configured to:
e) determine moving direction (A) of the detected and identified animal based on the image data from the imaging device, control the unmanned vehicle towards the detected and identified based on the moving direction (A) of the detected and identified animal in the predetermined geographical surveillance area; or
c) determine location and moving direction (A) of the detected and identified animal based on the image data from the imaging device, control the unmanned vehicle towards the detected and identified based on the location and moving direction (A) of the detected and identified animal in the predetermined geographical surveillance area; or
c) determine location and moving direction (A) of the detected and identified animal in the predetermined geographical surveillance area in relation to the surveillance area border based on the image data from the imaging device, control the unmanned vehicle towards the detected and identified based on the location and moving direction (A) of the detected and identified animal in the predetermined geographical surveillance area in the approach direction (D) in which the detected and identified animal is located between the unmanned vehicle and the surveillance area border for repelling the animal out of the predetermined geographical surveillance area; or
e) determine location and moving direction (A) of the detected and identified animal in the predetermined geographical surveillance area in relation to the surveillance area border based on the image data from the imaging device, control the unmanned vehicle towards the detected and identified based on the location and moving direction (A) of the detected and identified animal in the predetermined geographical surveillance area in the approach direction (D) in which the detected and identified animal is located between the unmanned vehicle and the surveillance area border for repelling the animal out of the predetermined geographical surveillance area, and
redetermine the location and moving direction (A) of the detected and identified animal in the predetermined geographical surveillance area in relation to the surveillance area border based on the image data from the imaging device, adjusting the approach direction (D) based on the redetermined location and moving direction (A) of the detected and identified animal in the predetermined geographical surveillance area such the detected and identified animal is located between the unmanned vehicle and the surveillance area border for repelling the animal out of the predetermined geographical surveillance area.

35. The repellence system according to claim 24, wherein the unmanned vehicle is an unmanned aerial vehicle.

36. The repellence system according to claim 35, wherein the repellence sub-system is configured to:
a) control movement of the unmanned aerial vehicle in the predetermined geographical surveillance area at a patrolling altitude, and
e) control the unmanned manned aerial vehicle to a repellence altitude as a response to c) detecting the animal in the image data, the repellence altitude being less than the patrolling altitude.

37. The method for repelling animals performed by a repellence system, wherein the repellence system comprising an unmanned vehicle having an imaging device and one or more deterrence devices, and repellence sub-system having one or more processors and memory storing instructions for execution by the one or more processors, the method comprising:
controlling the unmanned vehicle in a predetermined geographical surveillance area having a surveillance area border defining the predetermined geographical surveillance area for patrolling in the predetermined geographical surveillance area,
generating image data from the predetermined geographical surveillance area with the imaging device during controlling the unmanned vehicle in the predetermined geographical surveillance area;
detecting an animal in the image data with the repellence sub-system,
identifying animal species of the detected animal in the image data with the repellence sub-system,
defining species specific deterrence instructions based on the identified animal species with the repellence sub-system,
controlling the unmanned vehicle towards the detected and identified animal in the predetermined geographical surveillance area, and
carrying out species specific deterrence actions based on the defined species specific deterrence instructions with the deterrence device.

38. The method for repelling animals performed by a repellence system, wherein the repellence system comprising an unmanned vehicle having an imaging device and one or more deterrence devices, and repellence sub-system having one or more processors and memory storing instructions for execution by the one or more processors, the method comprising:
controlling the unmanned vehicle in a predetermined geographical surveillance area having a surveillance area border defining the predetermined geographical surveillance area for patrolling in the predetermined geographical surveillance area,
generating image data from the predetermined geographical surveillance area with the imaging device during controlling the unmanned vehicle in the predetermined geographical surveillance area;
detecting an animal in the image data with the repellence sub-system,
identifying animal species of the detected animal in the image data with the repellence sub-system,
defining species specific deterrence instructions based on the identified animal species with the repellence sub-system,
controlling the unmanned vehicle towards the detected and identified animal in the predetermined geographical surveillance area, and
carrying out species specific deterrence actions based on the defined species specific deterrence instructions with the deterrence device, wherein in that the method is carried out with a repellence system according to claim 24.
